(19) United States
(12) Patent Application Publication
(10) Pub. No.: US 2014/0032935 A1
(43) Pub. Date: Jan. 30, 2014

(54) MEMORY SYSTEM AND ENCRYPTION METHOD IN MEMORY SYSTEM

(71) Applicant: SAMSUNG ELECTRONICS CO., LTD., Suwon-si (KR)

(72) Inventors: KWANG-HOON KIM, SEOUL (KR); JUN-JIN KONG, YONGIN-SI (KR); HONGRAK SON, ANYANG-SI (KR)

(73) Assignee: SAMSUNG ELECTRONICS CO., LTD., SUWON-SI (KR)

(21) Appl. No.: 13/839,156

(22) Filed: Mar. 15, 2013

(30) Foreign Application Priority Data
Jul. 24, 2012 (KR) 10-2012-0080800

(51) Int. Cl. G06F 21/60

(52) U.S. Cl. CPC G06F 21/602
USPC 713/193

(57) ABSTRACT

An encryption method used in the memory system includes; generating a private key using physical unique identification (PUID) information of a nonvolatile memory device, encrypting data using the private key, and then programming the encrypted data in the nonvolatile memory device.

### CROSS-REFERENCE TO RELATED APPLICATIONS

This application claims the benefit of Korean Patent Application No. 10-2012-0080800 filed on Jul. 24, 2012, the subject matter of which is hereby incorporated by reference.

### BACKGROUND

The inventive concept relates generally to memory systems and data security methods used in memory systems. More particularly, the inventive concept relates to memory systems and data encryption methods used in memory systems.

Flash memory chips and/or other types of non-volatile memory chips are commonly used to implement many contemporary memory systems. Within such memory systems, data encryption is one technique used to secure stored data and prevent unauthorized data access. One or more data encryption capabilities may be incorporated into a memory system as part of an overall data security strategy.

However, most data encryption methods rely on one or more encryption key(s). A keys is usually created as specific data value that may be used to convert “normal data” (e.g., data as received by a memory system) into encrypted data, and conversely to convert encrypted data back into normal data. Many different encryption mechanism and methods use at least one key, and key may be created using a variety of numeric combinatorial schemes. Conventionally, encryption keys are stored in some secure data location (e.g., a nonvolatile memory) and retrieved upon memory system initialization. Unfortunately, increasingly sophisticated attacks have been directed to the derivation or acquisition of encryption keys within memory systems. Once an encryption key is obtained, unauthorized attacks on “secure” data stored in a memory system are made significantly more likely to succeed.

### SUMMARY

Embodiments of the inventive concept provide encryption methods used in a memory systems that are able to better protect stored data by (e.g.,) increasing the “randomness” of encryption keys. Other embodiments of the inventive concept provide memory systems capable of better protecting stored data by increasing the randomness of encryption keys.

According to an aspect of the inventive concept, there is provided an encryption method for use in a memory system including a nonvolatile memory device, the method comprising; receiving data to be stored in the nonvolatile memory device, generating a private key using physical unique identification (PUID) information related to the nonvolatile memory device, encrypting the data using the private key, and programming the encrypted data in the memory device.

According to another aspect of the inventive concept, there is provided a memory system comprising; a nonvolatile memory device comprising at least one memory chip, and a memory controller that controls operation of the nonvolatile memory device to encrypt data using information related to physical page addresses (PPAs) of the nonvolatile memory device, and to write the encrypted data to the nonvolatile memory device according to a physical page address (PPA) corresponding to a logical address for the data.

According to another aspect of the inventive concept, there is provided an encryption method for use in a memory system including a flash memory device having associated physical unique identification (PUID) information, the memory system being connected to a host, and the method comprising; receiving a write command, write data and a logical address for the write data in the memory system as communicated by the host, generating a private key using the PUID information, encrypting the write data using the private key to generate encrypted data, and programming the encrypted data in the flash memory device.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a memory system according to an embodiment of the inventive concept;

FIG. 2 is a block diagram of a memory system including a plurality of channels, according to another embodiment of the inventive concept;

FIG. 3 is a conceptual diagram of the channels and ways in the memory system of FIG. 2 according to an embodiment of the inventive concept;

FIG. 4 is a block diagram of a flash memory chip that may be included in the memory system of FIGS. 1 and/or 2;

FIG. 5 is a block diagram illustrating one possible internal storage structure for the flash memory chip of FIG. 4;

FIG. 6 is a conceptual diagram of one possible structure for software running on the processor and/or memory controller of FIGS. 1 and/or 2;

FIG. 7A is a conceptual diagram illustrating a page mapping method that may be used in the memory system of FIGS. 1 and/or 2;

FIG. 7B is a conceptual diagram illustrating a block mapping method that may be used in the memory system of FIGS. 1 and/or 2;

FIG. 7C is a conceptual diagram illustrating a hybrid mapping method that may be used in the memory system of FIGS. 1 and/or 2;

FIG. 8 is a block diagram further illustrating the encryption module of FIG. 1 according to an embodiment of the inventive concept;

FIG. 9 is a block diagram further illustrating the encryption module of FIG. 1 according to another embodiment of the inventive concept;

FIG. 10 is a block diagram further illustrating the private key generating unit of FIGS. 8 and 9 according to an embodiment of the inventive concept;

FIG. 11 is a block diagram further illustrating an encryption system that may be used to generate a symmetric key using a Diffie-Hellman (DH) key exchange algorithm according to an embodiment of the inventive concept;

FIG. 12 is a conceptual diagram illustrating an operation generating an initial key value according to an embodiment of the inventive concept;

FIG. 13 is a conceptual diagram illustrating an operation generating an initial key value according to another embodiment of the inventive concept;

FIG. 14 is a conceptual diagram illustrating physical page addresses (PPAs) of a memory system including two flash memory chips according to an embodiment of the inventive concept;

FIG. 15 is a conceptual diagram illustrating an operation generating an initial key value in the memory system of FIG. 14 according to another embodiment of the inventive concept;

FIG. 16 is a conceptual diagram illustrating an operation generating an encryption key according to an embodiment of the inventive concept;

FIG. 17 is a block diagram further illustrating an encryption method being applied within an embodiment of the inventive concept;

FIG. 18 is a block diagram of a server system using an encryption method according to an embodiment of the inventive concept;

FIG. 19 is a conceptual diagram illustrating an encryption operation in the memory system of FIGS. 1 and/or 2 according to an embodiment of the inventive concept;

FIG. 20 is a flowchart summarizing an encryption method that may be used in the memory system of FIGS. 1 and/or 2 according to an embodiment of the inventive concept;

FIG. 21 is a flowchart further illustrating the step of generating a private key in the encryption method of FIG. 20 according to an embodiment of the inventive concept;

FIG. 22 is a flowchart further illustrating a sub-step of determining a private key value in the method of FIG. 21 according to an embodiment of the inventive concept;

FIG. 23 is a flowchart summarizing an encryption method that may be used in the memory system of FIGS. 1 and/or 2 according to another embodiment of the inventive concept;

FIG. 24 is a flowchart summarizing a write operation that may be performed in the memory system of FIG. 1 or 2 according to an embodiment of the inventive concept;

FIG. 25 is a flowchart summarizing a read operation that may be performed in the memory system of FIGS. 1 and/or 2 according to an embodiment of the inventive concept;

FIG. 26 is a block diagram of an electronic device including the memory system of FIGS. 1 and/or 2 according to an embodiment of the inventive concept;

FIG. 27 is a block diagram of a memory card system including the memory system of FIGS. 1 and/or 2 according to an embodiment of the inventive concept; and

FIG. 28 is a block diagram of a networked server system including an SSD according to an embodiment of the inventive concept.

### DETAILED DESCRIPTION

Certain embodiments of the inventive concept will now be described with reference to the accompanying drawings. The inventive concept may, however, be variously embodied and should not be construed as being limited to only the illustrated embodiments. Rather, the illustrated embodiments are presented to teach the making an used of the inventive concept to those skilled in the art. Throughout the written description and drawings, like reference numbers and labels are used to denote like or similar elements and features.

As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

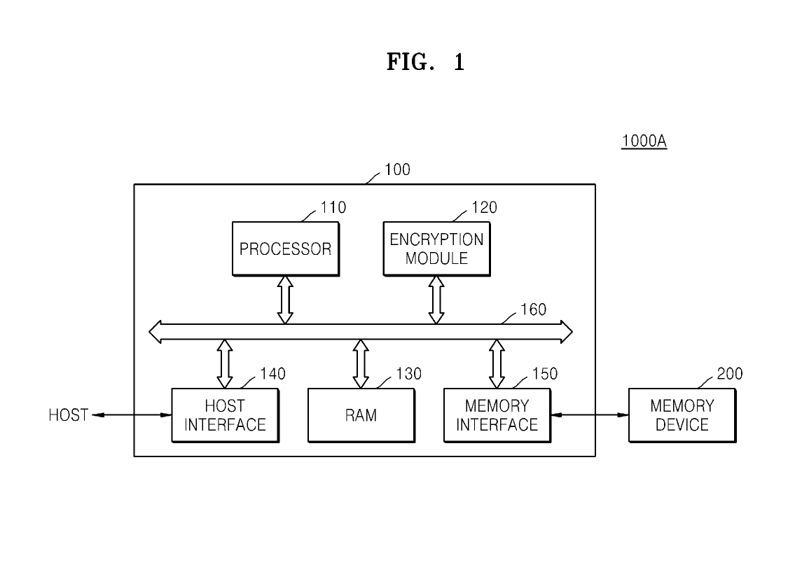

Figure (FIG. 1 is a block diagram of a memory system 1000A according to an embodiment of the inventive concept.

As illustrated in FIG. 1, the memory system 1000A includes a memory controller 100 and a memory device 200.

The memory device 200 may be a non-volatile memory device. For example, the memory device 200 may be a flash memory device, a phase change random access memory (RAM) (PRAM) device, a ferroelectric RAM (FRAM) device, or a magnetic RAM (MRAM) device. The memory device 200 may include at least one non-volatile memory device and at least one volatile memory device combined with each other, or at least two kinds of non-volatile memory devices combined with each other.

The memory device 200 may include a single flash chip or a plurality of flash memory chips.

The memory controller 100 includes a processor 110, an encryption module 120, a random access memory (RAM) 130, a host interface 140, a memory interface 150, and a bus 160.

The memory controller 100 controls the memory system 1000A in order to execute (or perform) selected erase, write, and/or read operation(s) with respect to the memory device 200 and in response to command(s) received from a host.

The memory controller 100 controls the memory device 200 to encrypt data using information related to a physical page address (PPA) of the memory device 200 and to write the resulting encrypted data to the physical page address (PPA) corresponding to a logical address at which data is to be stored.

An exemplary operation of the memory controller 100 will now be described.

The processor 110 is connected to the encryption module 120, the RAM 130, the host interface 140, and the memory interface 150 via the bus 160. The bus 160 may serve as a data transmission path among the various components of the memory controller 100.

The processor 110 controls the overall operation of the memory system 1000A. For example, the processor 110 may be used to control the memory system 1000A to decrypt the command received from the host and to perform an operation according to a result of decryption.

The processor 110 provides a read command and corresponding address to the memory device 200 during a read operation, and the processor 110 provides a write command, write data, and corresponding address to the memory device 200 during a write operation. The processor 110 may also convert the logical address received from the host into a PPA using meta data stored in the RAM 130.

Data transmitted from the host, data generated by the processor 110, and/or data read by the memory device 200 may be temporarily stored in the RAM 130. Unique identification (UID) information that is read by the memory device 200 may also be stored in the RAM 130. When the memory device 200 includes a plurality of memory chips, the UID information read from each of the plurality of memory chips may be stored in the RAM 130. In addition, the meta data read by the memory device 200 may be stored in the RAM 130. The RAM 130 may be implemented using volatile memory, such as a dynamic RAM (DRAM), a static RAM (SRAM), or the like.

“Meta data” is information generated by the memory system 1000A and is generally used to manage the memory device 200. Meta data includes management information such as mapping table information used to convert the logical address into the PPA of the memory device 200. For example, meta data may include page mapping information required to perform address mapping in defined page units. In addition, meta data may include information used to manage memory space in the memory device 200.

The host interface 140 implements one or more conventional data communication protocol(s) that may be used to exchange data between the host and the memory device 200. For example, the host interface 140 may be an advanced technology attachment (ATA) interface, a serial advanced technology attachment (SATA) interface, a parallel advanced technology attachment (PATA) interface, a universal serial bus (USB) or a serial attached small computer system (SAS) interface, a small computer system interface (SCSI), an embedded multi media card (eMMC) interface, or a UNIX file system (UFS) interface. However, embodiments of the inventive concept are not limited thereto.

In certain embodiments, the host interface 140 may control the exchange of data, commands, and/or addresses between the host and processor 110.

The memory interface 150 is connected to the memory device 200. The memory interface 150 may be configured to support an interface with a NAND flash memory chip or a NOR flash memory chip. The memory interface 150 may be configured in such a way that software and hardware interleaving operations may be selectively performed via a plurality of channels.

The processor 110 controls the memory system 1000A to read the meta data stored in the memory device 200 and to store the meta data in the RAM 130 if power is supplied to the memory system 1000A. The processor 110 controls the memory system 1000A to update the meta data stored in the RAM 130 according to an operation of changing the metal data in the memory device 200. The processor 110 controls the memory system 1000A to write the metal data stored in the RAM 130 into the memory device 200 before the memory system 1000A is powered off.

The encryption module 120 may include hardware and software components configured to encrypt and/or decrypt (hereafter “encrypt/decrypt”) data using at least a portion of the PPA of the memory device 200.

The encryption module 120 may be designed so that part or all of the encryption module 120 is included in the memory device 200. Alternatively, the encryption module 120 may be designed so that part or all of the encryption module 120 is included in a device disposed at the host.

The encryption module 120 may generate an initial key value using at least a portion of at least one PPA of the memory device 200 in which data is to be stored, and may generate a private key having an initially set size based on the initial key value, and may encrypt the data using the generated private key.

The encryption module 120 may generate an initial key value by combining information related to at least one PPA of the memory device 200 in which data is to be stored and the UID information of the memory device 200.

For example, the encryption module 120 may generate an initial key value as bit map information that is used in differentiating PPAs in which data is to be stored and PPAs in which data is not to be stored from among PPAs included in a memory chip in which data is to be stored in the memory device 200.

For example, the encryption module 120 may generate an initial key value by combining UID information of a plurality of memory chips with information related to PPAs to be stored in the plurality of memory chips when the memory device 200 includes the plurality of memory chips.

For example, the encryption module 120 may generate an initial key value by combining information regarding a PPA to be stored in each of a plurality of channels and a plurality of ways in the form of stripes when the memory device 200 includes a plurality of flash memory devices in which the plurality of channels and the plurality of ways are arranged.

For example, the encryption module 120 may generate a private key from the initial key value using a hash function, or, the encryption module 120 may generate a private key from the initial key value using a hash function and pseudo random number generator.

In certain embodiments, the encryption module 120 may generate the same symmetric key in the memory system 1000A and the host using a key exchange algorithm in relation to the private key. The encryption module 120 may generate the same symmetric key in the memory system 1000A and the host by applying a Diffie-Hellman (DH) key exchange algorithm, for example. In such cases, the encryption module 120 may encrypt data using the symmetric key.

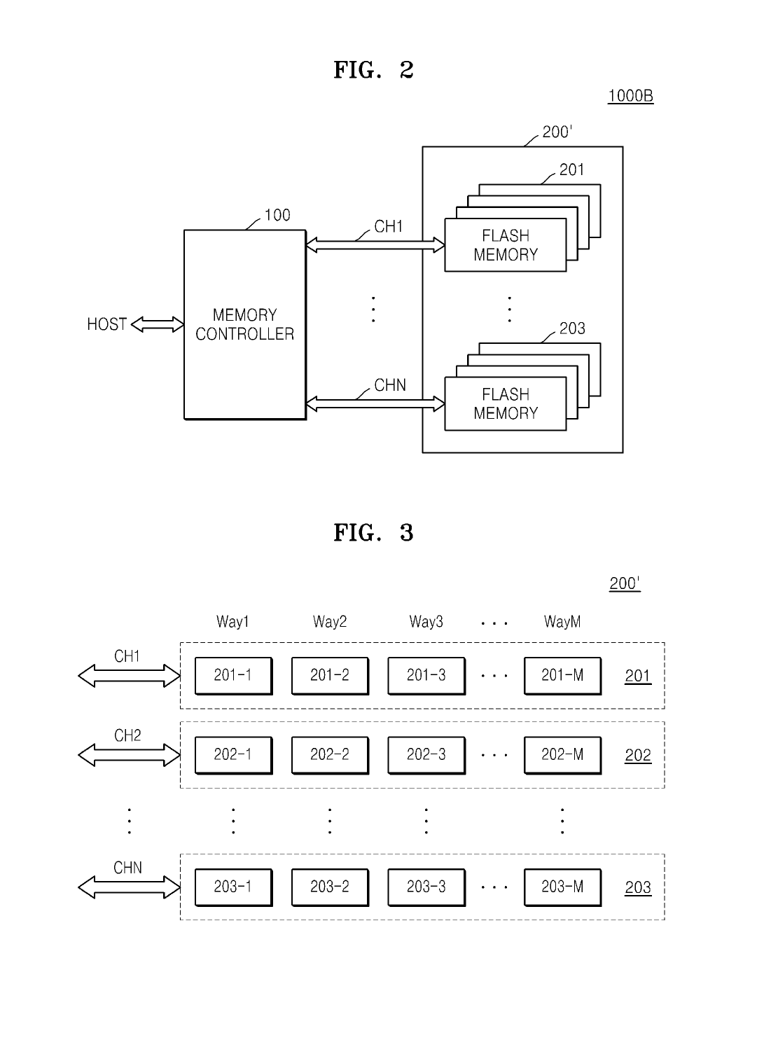

FIG. 2 is a block diagram of a memory system 1000B in which the memory device 200 illustrated in FIG. 1 includes a plurality of memory chips so that a plurality of channels and a plurality of ways may be formed according to another embodiment of the inventive concept.

The memory system 1000B illustrated in FIG. 2 may be implemented as a solid state drive (SSD), or solid state disc.

Referring to FIG. 2, a memory device 200′ of the memory system 1000B is implemented with a plurality of flash memory chips 201 and 203.

The memory system 1000B may include N channels, where N is any reasonable natural number. Multiple flash memory chips (e.g., 4) may be connected to each of the channels.

The configuration of the memory controller 100 illustrated in FIG. 2 is substantially the same as the configuration of the memory controller 100 illustrated in FIG. 1 and thus, redundant descriptions thereof will be omitted.

FIG. 3 is a conceptual diagram illustrating one possible structure for channels and ways of the memory system 1000B of FIG. 2 according to an embodiment of the inventive concept.

A plurality of flash memory chips 201, 202, and 203 may be connected to channels CH1 to CHN. Each of the channels CH1 to CHN may refer to an independent bus that may receive or transmit a command, an address, and data from or to the flash memory chips 201, 202, and 203. Each of the plurality of flash memory chips 201, 202, and 203 that are connected to different channels CH1 to CHN, may operate independently. The plurality of memory chips 201, 202, and 203 that are connected to the different channels CH1 to CHN may form a plurality of ways way1 to wayM. Thus, “M” flash memory chips are connected in the M ways formed between the channels CH1 to CHN.

For example, flash memory chips 201 may form M ways way1 to wayM at a first channel CH1. Flash memory chips 201-1 to 201-M may be connected to the M ways way1 to wayM at the first channel CH1. The formation relationship between the flash memory chips 201-1 to 201-M, the channels CH1 to CHN, and the M ways way1 to wayM may be applied to flash memory chips 202 and the flash memory chips 203.

A way is the unit for differentiating flash memory chips that share the same channel. The flash memory chips may be differentiated according to a channel number and a way number. It may be determined based on a logical address transmitted from the host which channel and which way of a flash memory chip in which a request provided from the host is to be performed.

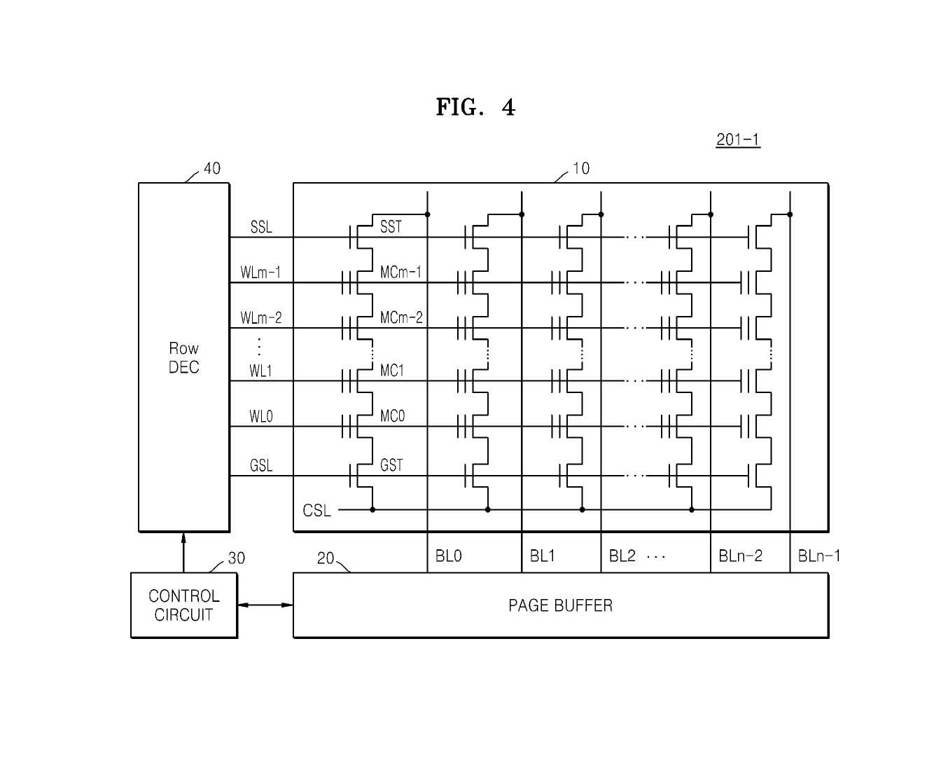

FIG. 4 is a block diagram further illustrating the flash memory chip 201-1 of the memory device 200′ of FIG. 3 included in the memory system 1000B of FIG. 2.

As illustrated in FIG. 4, the flash memory chip 201-1 may include a cell array 10, a page buffer 20, a control circuit 30, and a row decoder 40.

The cell array 10 is an area in which data is written in a way that a predetermined voltage to a transistor. The cell array 10 includes memory cells formed where wordlines WL0 to WLm-1 and bitlines BL0 to BLn-1 cross one another. Here, “m” and “n” are natural numbers. FIG. 4 illustrates only one memory block; however, the cell array 10 may include a plurality of memory blocks. Each of the plurality of memory blocks includes pages corresponding to the wordlines WL0 to WLm-1. Each of the pages includes a plurality of memory cells connected to the wordlines WL0 to WLm-1. The flash memory chip 201-1 performs erase operations in block units, and performs program (data write) operations and read operations in page units.

The memory cell array 10 has a cell string structure. Each cell string includes a string selection transistor (SST) that is connected to a string selection line (SSL), a plurality of memory cells MC0 to MCm-1 that are connected to the plurality of wordlines WL0 to WLm-1, and a ground selection transistor (GST) that is connected to a ground selection line (GSL). Here, the string selection transistor (SST) is connected between a bitline and a string channel, and the ground selection transistor (GST) is connected between the string channel and a common source line (CSL).

The page buffer 20 is connected to the cell array 10 via the plurality of bitlines BL0 to BLn-1. The page buffer 20 stores data to be written into the memory cells connected to selected wordlines or data read from the memory cells connected to selected wordlines temporarily.

The control circuit 30 generates various voltages required to perform a program, read, and/or erase operation(s) and controls all operations of the flash memory chip 201-1.

The row decoder 40 is connected to the cell array 10 via the selection lines SSL and GSL and the plurality of wordlines WL0 to WLm-1. The row decoder 40 receives an address that is input during a programming or read operation, and selects one wordline from among the wordlines WL0 to WLm-1 according to the input address. Memory cells in which the programming or read operation is to be performed are connected to the selected wordline.

In addition, the row decoder 40 applies voltages required to perform the programming or read operation, for example, a program voltage, a pass voltage, a read voltage, a string selection voltage, and a ground selection voltage, to the selected wordline, unselected wordlines, and the selection lines SSL and GSL.

Each of the memory cells may store 1-bit data or 2 or more-bit data. A memory cell in which 1-bit data is stored, is referred to a single level cell (SLC). A memory cell in which 2 or more-bit data is stored is referred to a multi level cell (MLC). The single level cell (SLC) has an erased state or a programmed state according to a threshold voltage. The reliability of the flash memory chip 201-1 including the multi level cell (MLC) is lowered due to a using time and a programming/erase cycle so that an error correction code (ECC) uncorrectable state may occur. A spare region exists in a physical page of the flash memory chip 201-1, and ECC information may be stored in the spare region.

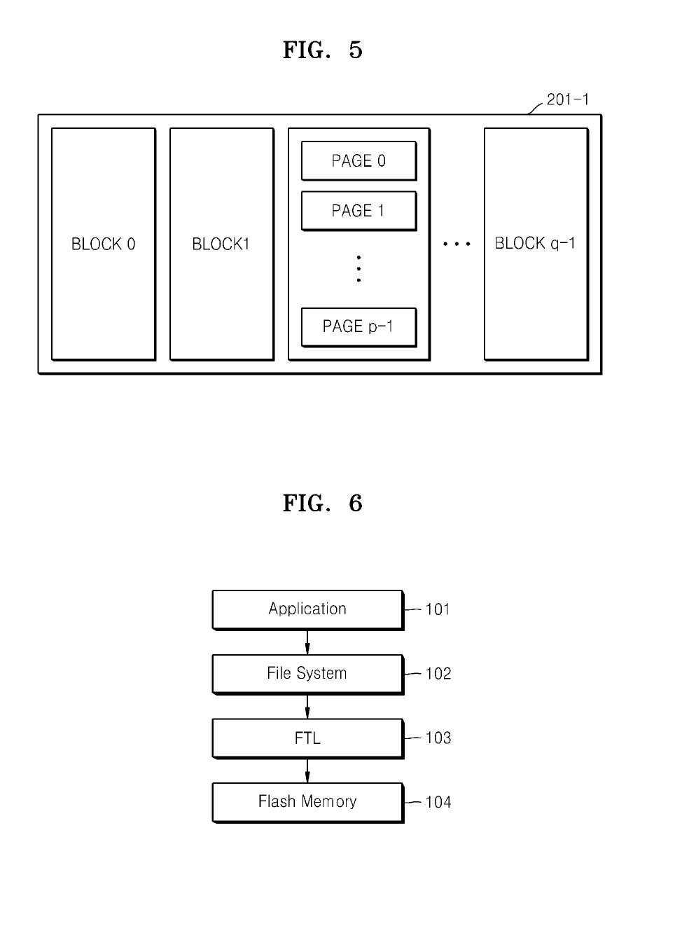

As further illustrated in FIG. 5, the internal structure of the flash memory chip 201-1 may include a plurality of blocks, wherein each of the plurality of blocks includes a plurality of pages.

Data is written to or read from the flash memory chip 201-1 in units of page, while data is erased from the flash memory chip 201-1 in units of block. In addition, an erase operation directed to a block must be performed before data is programmed to the flash memory chip 201-1. Thus, a direct data overwrite operation for the flash memory chip 201-1 is not possible.

In memory devices lacking a direct data overwrite capability, user data may not be written directed to a desired physical location of the flash memory chip 201-1. Thus, when access is requested by the host so as to perform a write or read operation, the process of converting a logical address that indicates an location at which the write or read operation is directed must be performed so that a corresponding PPA is defined that properly indicates a physical area in which data is actually stored or will be stored.

The process of converting a logical address of the memory system 1000A or 1000B illustrated in FIG. 1 or 2 into a corresponding PPA will now be described with reference to FIG. 6.

FIG. 6 is a block diagram of a software structure of the memory system 1000A or 1000B illustrated in FIGS. 1 and 2. For example, FIG. 6 illustrates a software structure when the memory device 200 of FIG. 1 is assumed to be flash memory device.

Referring to FIG. 6, the memory system 1000A or 1000B has a software layer structure including an application layer 101, a file system layer 102, a flash translation layer (FTL) 103, and a flash memory layer 104.

The application layer 101 is firmware that processes data in response to a user input from the host. On the application layer 101, user data is processed in response to the user input, and a command for storing the processed user data in a flash memory chip is transferred to the file system layer 102.

A logical address in which the user data is to be stored is allocated to the file system layer 102 in response to the command transferred from the application layer 101. The file system layer 102 includes a file allocation table (FAT) file system, an NTFS, or the like.

On the FTL 103, an operation of converting the logical address transferred from the file system layer 102 into a PPA for performing a read/write operation from/in the flash memory chip is performed. On the FTL 103, the logical address may be converted into the PPA using mapping information included in meta data. The address converting operation on the FTL 103 may be performed by the processor 110 of the memory controller 100.

On the flash memory layer 104, control signals for storing or reading data in or from the flash memory chip are generated by accessing the PPA that is converted from the logical address.

An address converting method may include a fully-associative page mapping method, a block mapping method, and a block associative mapping method.

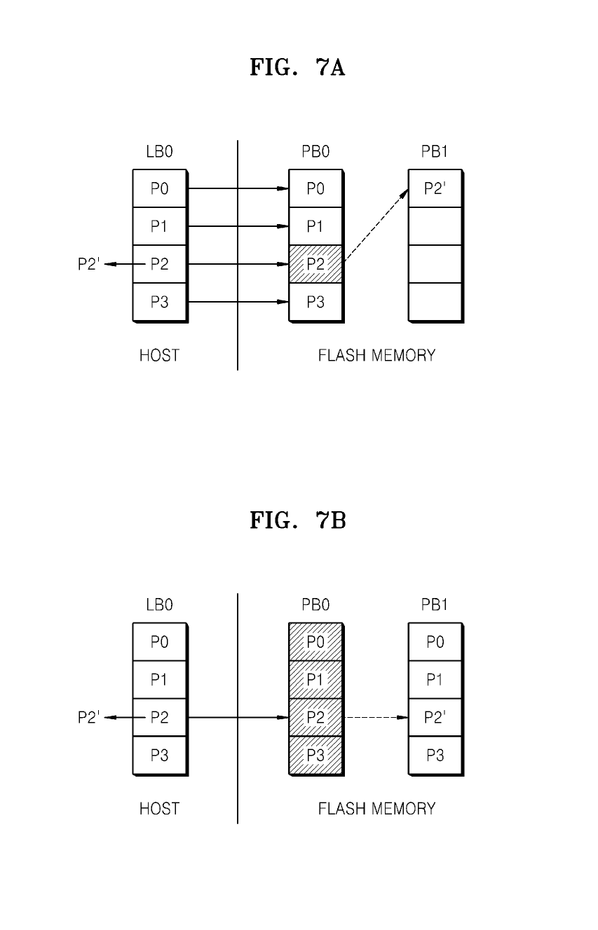

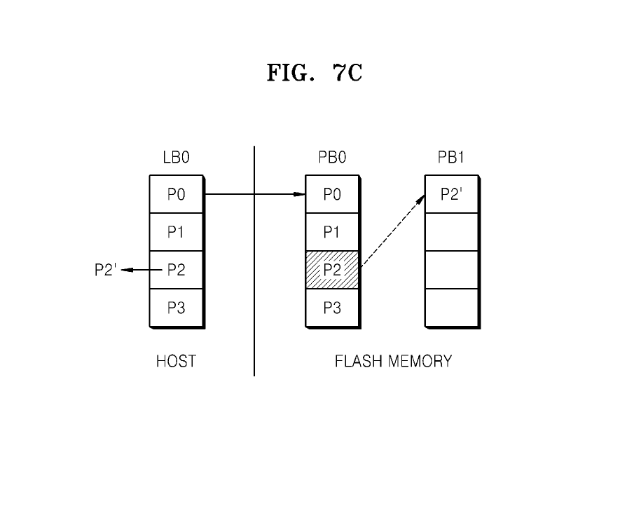

FIG. 7A is a conceptual diagram illustrating of a page mapping method for the memory system 1000A or 1000B illustrated in FIG. 1 or 2.

Referring to FIG. 7A, an address converting operation is performed based on mapping information that is generated in the units of page. Thus, an address is converted into a log block PB0 based on mapping information related to pages P0 to P3 that constitute a logical data block LB0. Here, the log block PB0 is a physical block of the flash memory chip. Thereafter, if a page P2 of the logical data block LB0 is updated to P2′, page mapping information for writing the updated P2′ is generated so as to write the updated P2′ in a new log block PB1 that is allocated to a data group. Then, the page P2 of the logic block PB0 is invalidated.

FIG. 7B is a conceptual diagram illustrating a block mapping method for the memory system 1000A or 1000B illustrated in FIG. 1 or 2.

Referring to FIG. 7B, an address converting operation is performed based on mapping information generated in units of block. Thus, mapping information related to pages P0 to P3 that constitute the logical data block LB0 is generated as one block mapping information, and an address of the logical data block LB0 is converted into the log block PB0 based on one block mapping information. Thereafter, if the page P2 of the logical data block LB0 is updated to P2′, block mapping information for writing all pages included in a block including the updated P2′is generated so as to write pages P0, P1, P3, and the updated page P2′ into a new log block PB1 allocated to the data group, and then, all pages of the log block PB0 are invalidated.

FIG. 7C is a conceptual diagram illustrating an address converting operation using a block associative mapping method.

Referring to FIG. 7C, when original data of the logical data block LB0 is written into the flash memory, an address converting operation is performed based on mapping information that is generated in units of block. Thus, mapping information related to pages P0 to P3 that constitute the logical data block LB0, is generated as one block mapping information, and an address is converted into the log block PB0 based on one block mapping information. Thereafter, if the page P2 of the logical data block LB0 is updated to P2′, page mapping information for writing the updated P2′ is generated so as to write the updated page P2′ into a new log block PB1 that is allocated to a data group, and the page P2 of the log block PB0 is invalidated.

Then, an encryption operation in the memory system 1000A illustrated in FIG. 1 will be described in detail.

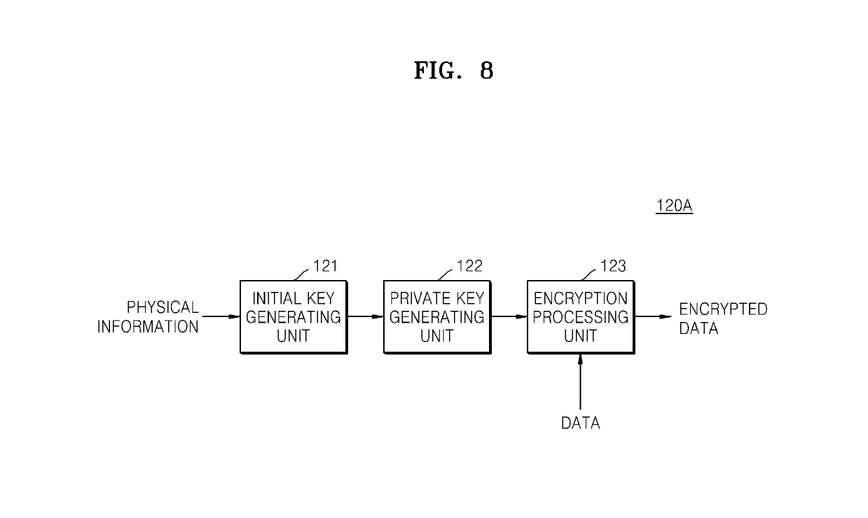

FIG. 8 is a block diagram illustrating an encryption module 120A as an example of the encryption module 120 of FIG. 1 according to an embodiment of the inventive concept.

As illustrated in FIG. 8, the encryption module 120A includes an initial key generating unit 121, a private key generating unit 122, and an encryption processing unit 123.

The initial key generating unit 121 generates an initial key value using physical unique identification (PUID) information of the memory device 200. For example, physical page address information may be included in the PUID information. UID information of the memory device 200 may be included in the PUID information. For example, the UID information of the memory device 200 may be stored in the memory device 200. In addition, the PUID information may include information that is generated by combining the physical page address information with the UID information of the memory device 200.

For example, the initial key generating unit 121 may generate an initial key value using one physical page address information that is converted by the processor 110. Alternatively, the initial key generating unit 121 may generate an initial key value using UID information of the memory device 200 that is read from the memory device 200. Alternatively, the initial key generating unit 121 may generate an initial key value by combining one physical page address information that is converted by the processor 110 with UID information of the memory device 200 that is read from the memory device 200.

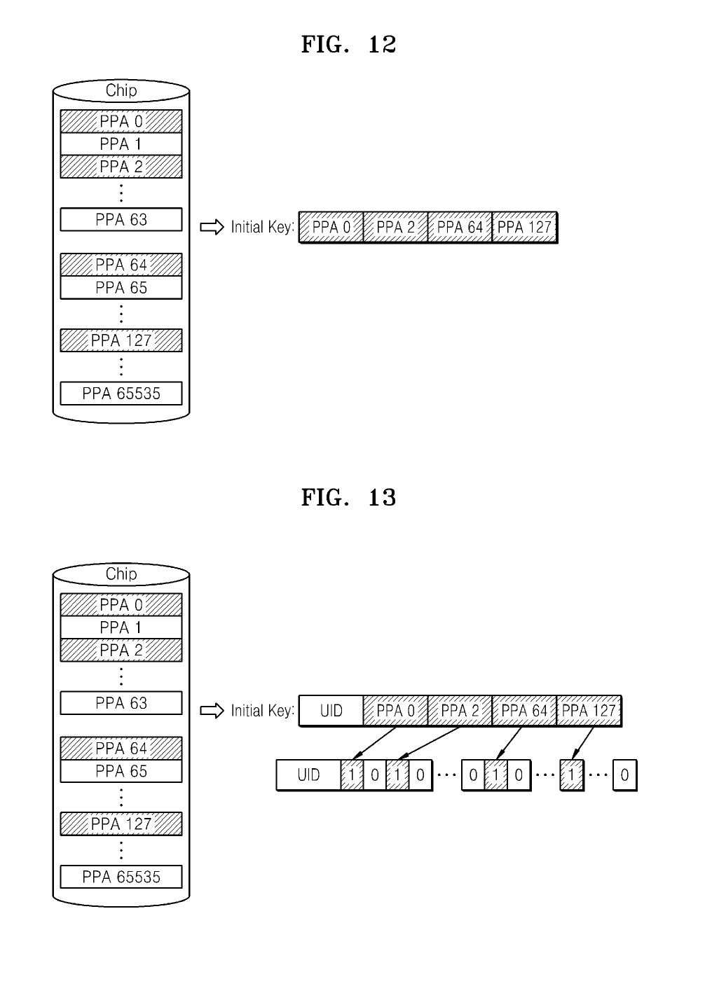

Examples of operation(s) generating an initial key value using the initial key generating unit 121 when the memory device 200 is implemented with a single flash memory chip are conceptually illustrated in FIGS. 12 an 13.

FIG. 12 is a conceptual diagram illustrating an operation generating an initial key value according to an embodiment of the inventive concept. FIG. 13 is a conceptual diagram illustrating an operation of generating an initial key value according to another embodiment of the inventive concept.

Referring to FIGS. 12 and 13, a single flash memory chip is assumed to include (2¹⁶) or 65,536 pages.

Referring to FIG. 12, when PPAs in which data is to be stored due to address conversion, are PPA0, PPA2, PPA64, and PPA127, an initial key may be generated with a value [PPA0 PPA2 PPA64 PPA127] that is obtained by combining four address-converted PPAs.

Alternatively, an initial key value may be generated by combining UID information of the single flash memory chip with the PPAs. That is, an initial key may be generated with a value [UID PPA0 PPA2 PPA64 PPA127] that is obtained by combining the UID of the single flash memory chip with four address-converted PPAs.

FIG. 13 illustrates an example of an operation of generating an initial key value that is used in differentiating PPAs included in the flash memory chip from PPAs in which data is to be stored and PPAs in which data is not to be stored.

Referring to FIG. 13, an initial key is generated by combining the UID information with a bit map including bits corresponding to the number of physical pages included in the flash memory chip.

For example, an initial key value may be determined by determining bits corresponding to the PPAs, such as PPA0, PPA2, PPA64, and PPA127 in which data is to be stored in the bit map as ‘1’ and by determining bits corresponding to PPAs in which data is not to be stored as ‘0’.

Alternatively, an initial key value may be determined by determining bits corresponding to PPAs, such as PPA0, PPA2, PPA64, and PPA127 in which data is to be stored in the bit map as ‘0’ and by determining bits corresponding to PPAs in which data is not to be stored as ‘1’.

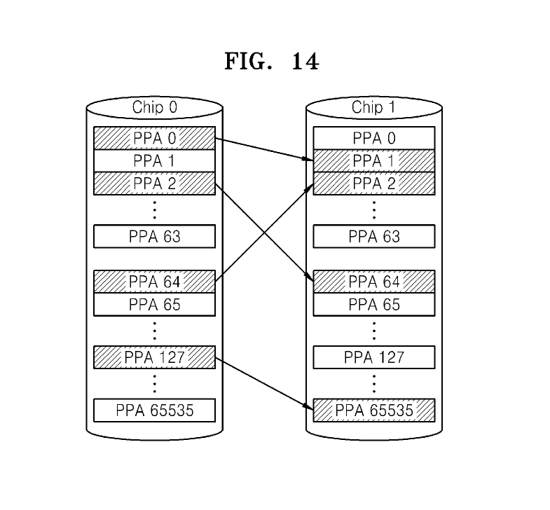

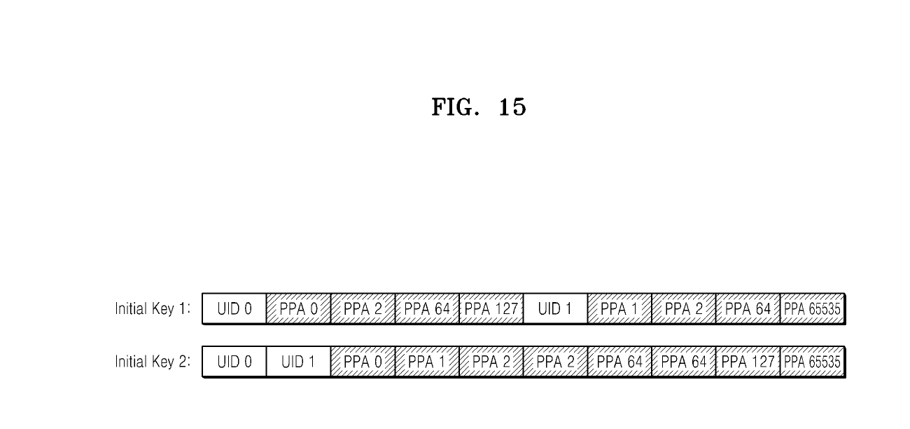

Alternatively, examples of an operation of generating an initial key value using the initial key generating unit 121 when the memory chip 200 is implemented with two flash memory chips are conceptually illustrated in FIGS. 14 and 15.

FIG. 14 is a conceptual diagram illustrating PPAs in a memory system including two flash memory chips according to an embodiment of the inventive concept.

Referring to FIG. 14, in the memory system, the same data are stored in different flash memory chips chip0 and chip1. This means that the same data is stored in pages that are indicated by arrows.

Thus, PPAs, such as PPA0, PPA2, PPA64, and PPA127 in which data is to be stored, are in Chip 0, and PPAs, such as PPA1, PPA2, PPA64, and PPA65535 in which data is to be stored, are in Chip 1.

FIG. 15 is a conceptual diagram illustrating an operation of generating an initial key value in the memory system illustrated in FIG. 14 according to another embodiment of the inventive concept.

Referring to FIG. 15, the initial key generating unit 121 may generate a first initial key Initial Key 1 with a value [UID0 PPA0 PPA2 PPA64 PPA127 UID1 PPA1 PPA2 PPA64 PPA65535] that is obtained by combining unique identification (UID) information UID0 of chip 0, PPAS, such as PPA0, PPA2, PPA64, and PPA127 in which data is to be stored, in Chip 0, UID information UID1 of chip 1, and PPAs, such as PPA1, PPA2, PPA64, and PPA65535 in which data is to be stored, in Chip 1.

Alternatively, the initial key generating unit 121 may generate a second initial key Initial Key 2 with a value [UID0 UID1 PPA0 PPA1 PPA2 PPA2 PPA64 PPA64 PPA127 PPA65535] that is obtained by combining UID information UID0 of Chip 0, UID information UID1 of Chip 1, and PPAs in which data is to be stored, in chip 0 and chip 1.

In FIGS. 12 and 15, when a write operation is directed to a page having a number less than the number of physical page address information required to generate an initial key value using the memory system, the initial key value may be generated by adding dummy information to converted physical page address information. For example, the initial key value may be generated by setting some pages from among pages that constitute a flash memory chip, to preparatory pages and by adding some PPAs included in the set preparatory pages as dummy information.

Referring back to FIG. 8, the private key generating unit 122 may generate a private key having an initially-set size based on the initial key value that is generated by the initial key generating unit 121.

For example, a private key value may be determined with a hash function value that is output by applying the initial key value to a hash function. For example, a 128-bit output value may be obtained regardless of the size of the input initial key value using an MD5 hash function. In this way, the 128-bit output value may be determined as the private key.

For example, a private key value may be determined by applying a hash function to one of the first initial key Initial Key 1 or the second initial key Initial Key 2.

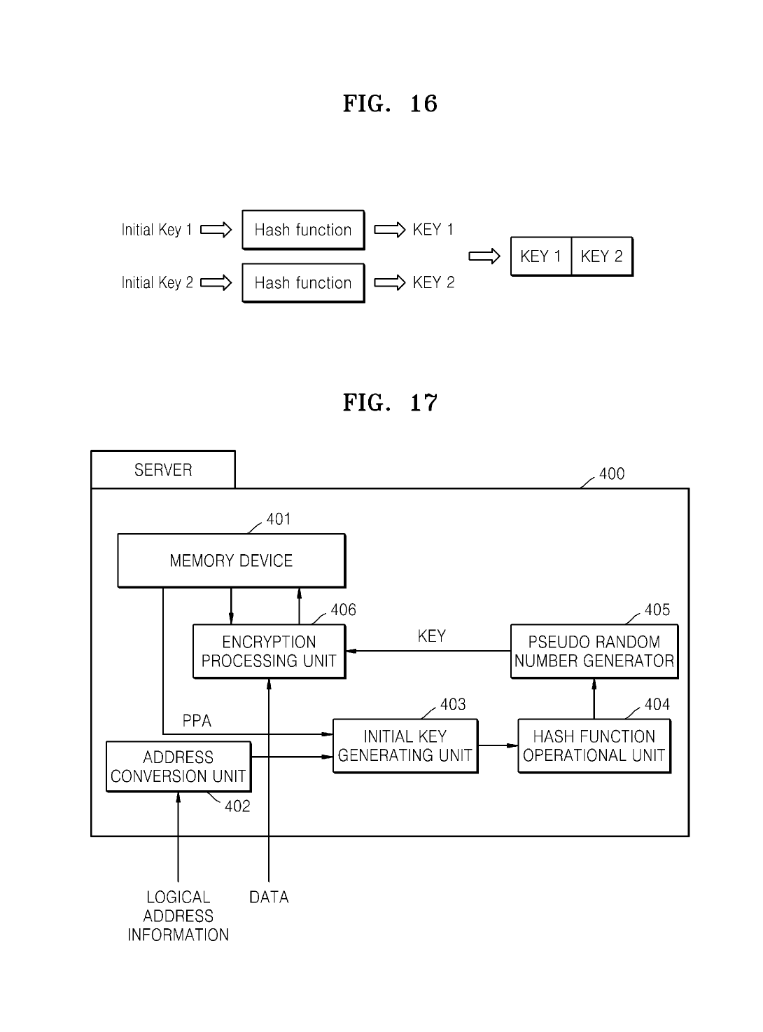

Alternatively, as illustrated in FIG. 16, a private key value may be determined as a value [KEY1 KEY2] that is obtained by combining KEY1 and KEY2 that are obtained by applying a hash function to the first initial key Initial Key 1 and the second initial key Initial Key 2, respectively. In FIG. 16, a 256-bit private key may be provided using two MD5 hash functions at an advanced encryption standard (AES) algorithm using a 256-bit symmetric key.

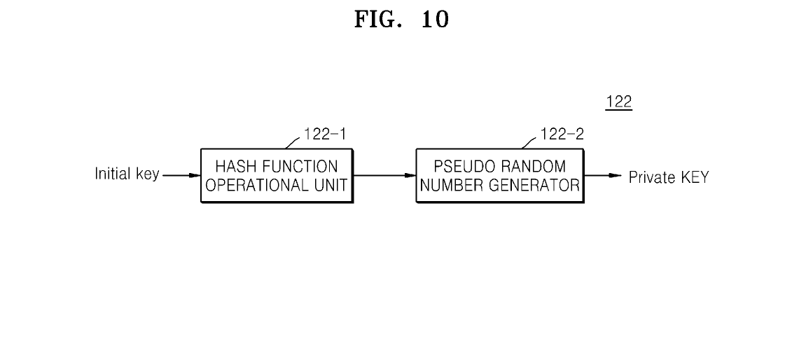

As illustrated in FIG. 10, the private key generating unit 122 may include a hash function operational unit 122-1 and a pseudo random number generator 122-2.

Referring to FIG. 10, the hash function operational unit 122-1 receives an initial key value and generates a hash function output value having an initially-set size by operating the initial key value with a hash function.

The pseudo random number generator 122-2 outputs a pseudo random number value using the hash function output value as a seed value. The pseudo random number generator 122-2 may determine the output pseudo random number value as a private key value.

Referring back to FIG. 8, the encryption processing unit 123 performs encryption on data to be stored in the memory device 200 using the private key generated by the private key generating unit 122. For example, the encryption processing unit 123 may perform encryption based on the AES algorithm. Other encryption algorithms having various specifications that encrypt data using a private key may be applied to the inventive concept.

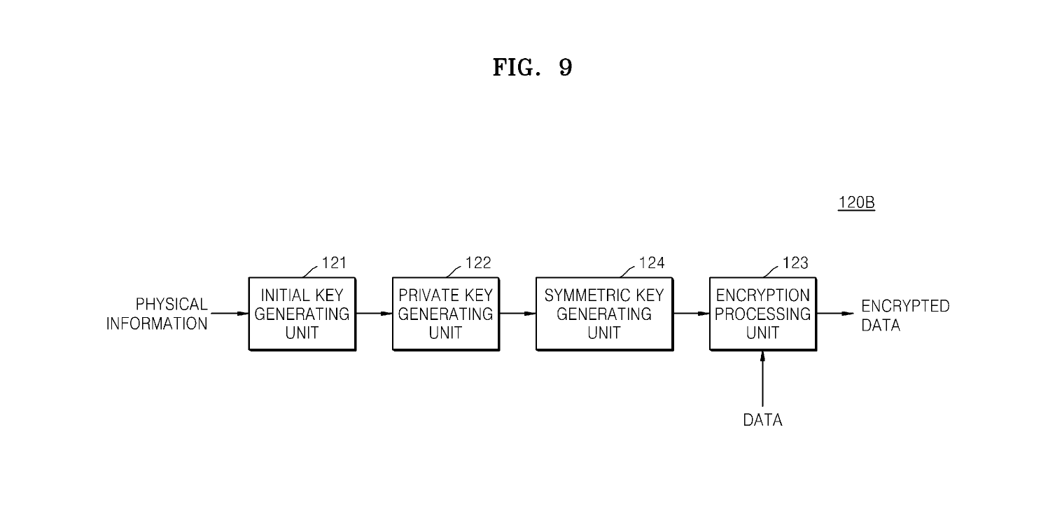

FIG. 9 is a block diagram illustrating an encryption module 120B as an example of the encryption module 120 of FIG. 1 according to another embodiment of the inventive concept.

As illustrated in FIG. 9, the encryption module 120B includes an initial key generating unit 121, a private key generating unit 122, a symmetric key generating unit 124, and an encryption processing unit 123.

The initial key generating unit 121, the private key generating unit 122, and the encryption processing unit 123 illustrated in FIG. 9 are substantially the same as the initial key generating unit 121, the private key generating unit 122, and the encryption processing unit 123 illustrated in FIG. 8, and thus redundant descriptions thereof will be omitted.

The encryption module 120B illustrated in FIG. 9 has a structure in which the symmetric key generating unit 124 is added between the private key generating unit 122 and the encryption processing unit 123 of the encryption module 120A of FIG. 8.

Referring to FIG. 9, the symmetric key generating unit 124 of the encryption module 120B receives a private key that is generated by the private key generating unit 122 and generates the same symmetric key in each of a memory system and a terminal that exchanges data with the memory system. For example, the symmetric key generating unit 124 may generate a symmetric key by suing a Diffie-Hellman (DH) key exchange algorithm.

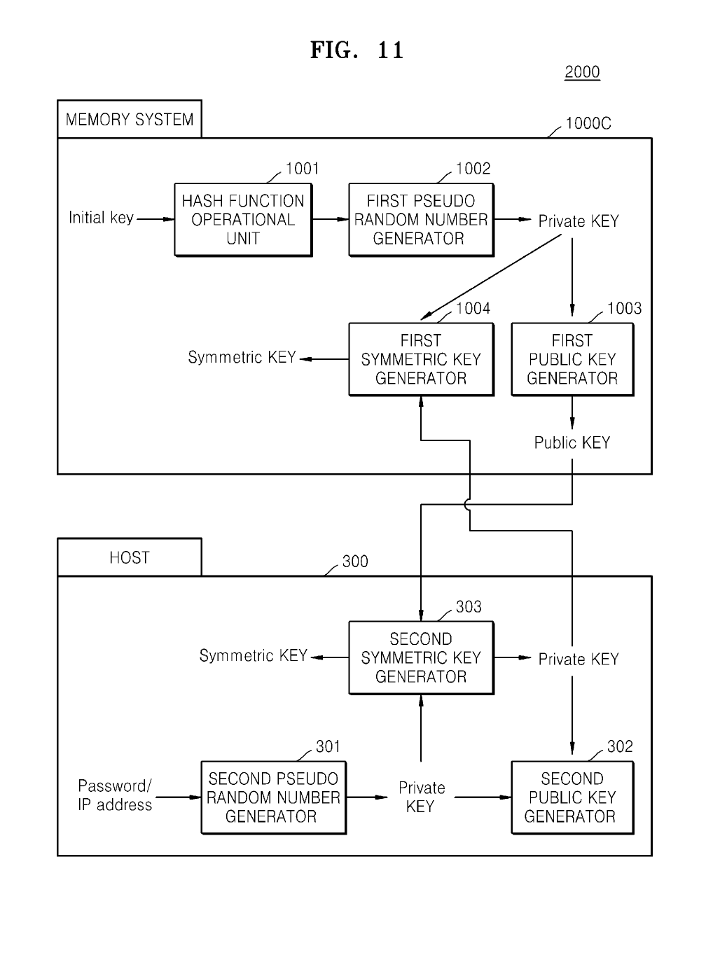

FIG. 11 is a block diagram illustrating an encryption system 2000 for generating a symmetric key by applying an initial key value to the Diffie-Hellman (DH) key exchange algorithm according to an embodiment of the inventive concept.

As illustrated in FIG. 11, the encryption system 2000 generates a symmetric key in each of a memory system 1000C and a host terminal 300.

The memory system 1000C includes a hash function operational unit 1001, a first pseudo random number generator 1002, a first public key generator 1003, and a first symmetric key generator 1004.

The host terminal 300 includes a second pseudo random number generator 301, a second public key generator 302, and a second symmetric key generator 303.

First, an operation of generating a symmetric key in the memory system 1000C will be described as below.

The hash function operational unit 1001 receives an initial key that is generated in the manner described with reference to FIG. 8 and outputs a hash function operational value having a predetermined size regardless of the size of the initial key by performing a hash function operation on the received initial key.

The first pseudo random number generator 1002 generates a pseudo random number value by applying the hash function operational value as a seed value. The pseudo random number value that is generated by the first pseudo random number generator 1002 is input to the first public key generator 1003 and the first symmetric key generator 1004.

In another embodiment of the inventive concept, the first pseudo random number generator 1002 may not be used. In this case, the hash function operational value that is output by the hash function operational unit 1001 is input to the first public key generator 1003 and the first symmetric key generator 1004.

The first public key generator 1003 generates a public key to be shared with the host terminal 300 using the DH key exchange algorithm. The public key that is generated by the first public key generator 1003 is transmitted to the host terminal 300.

The first symmetric key generator 1004 generates a symmetric key according to the DH key exchange algorithm based on the public key that is transmitted from the host terminal 300 and the private key that is input from the hash function operational unit 1001 or the first pseudo random number generator 1002. The symmetric key corresponds to a final encryption key that is used in performing encryption.

Next, an operation of generating a symmetric key in the host terminal 300 will be described as below.

The second pseudo random number generator 301 generates a pseudo random number value using a password or an Internet protocol (IP) address of the host terminal 300 as a seed value. The pseudo random number value that is generated by the second pseudo random number generator 301 is input to the second public key generator 302 and the second symmetric key generator 303.

The second public key generator 302 generates a public key to be shared with the memory system 1000C using the DH key exchange algorithm. The public key that is generated by the second public key generator 302 is transmitted to the memory system 1000C.

The second symmetric key generator 303 generates a symmetric key according to the DH algorithm based on the public key that is transmitted from the memory system 1000C and the private key that is input from the second pseudo random number generator 301.

According to the DH key exchange algorithm, the symmetric key that is generated in the memory system 1000C and the symmetric key that is generated in the host terminal 300 are the same.

In another embodiment of the inventive concept, in FIG. 11, the memory system 1000C may be a server, and the host terminal 300 may be a client terminal.

FIG. 17 is a block diagram illustrating a server 400 in which an encryption method according to an embodiment of the inventive concept may be applied.

As illustrated in FIG. 17, the server 400 includes a memory device 401, an address conversion unit 402, an initial key generating unit 403, a hash function operational unit 404, a pseudo random number generator 405, and an encryption processing unit 406.

The memory device 401 as a main storage device of the server 400 may include an array of flash memory chips. In addition, the memory device 401 may include one or more solid state drives (SSDs).

If new data and logical address information to be stored in the memory device 401 are input to the server 400, the address conversion unit 402 converts a logical address into a PPA and transmits the PPA to the initial key generating unit 403. Conversion into the PPA may be performed using software, such as the FTL described above.

Alternatively, when data is restored by changing a position of the memory device 401 in which data is stored, the PPA to be newly stored in the memory device 401 is transmitted to the initial key generating unit 403. The case that data is restored by changing a position of the memory device 401 in which data is stored is an example and may occur in a garbage collection process.

The initial key generating unit 403 generates an initial key value using the input PPA. The initial key generating unit 403 may generate an initial key value in various manners described with reference to the initial key generating unit 121 of FIG. 8.

The hash function operational unit 404 generates a hash function value having a predetermined size regardless of the size of the initial key value using a hash function.

The pseudo random number generating unit 405 outputs a pseudo random number value using the hash function value as a seed value. The output pseudo random number value may be determined as a private key value.

The use of the pseudo random number generating unit 405 in the server 400 is optional. If the pseudo random number generating unit 405 is not used, a hash function operational value to be output from the hash function operational unit 404 may be used as a private key value.

The encryption processing unit 406 encrypts data input to the server 400 or data read from the memory device 401 using the private key value. For example, encryption may be performed based on an encryption algorithm, such as an AES algorithm.

In this way, encrypted data is written into a PPA of the memory device 401 that is used in generating the initial key value.

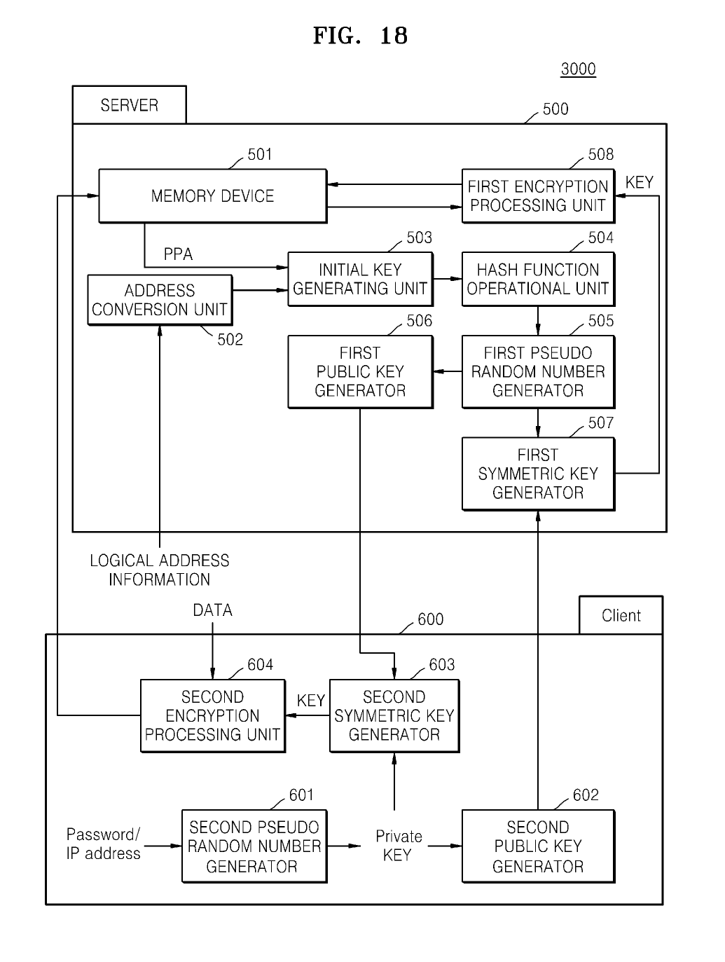

FIG. 18 is a block diagram illustrating a server system 3000 to which an encryption method according to an embodiment of the inventive concept may be applied.

As illustrated in FIG. 18, the server system 3000 includes a server 500 and a client terminal 600.

The server 500 includes a memory device 501, an address conversion unit 502, an initial key generating unit 503, a hash function operational unit 504, a first pseudo random number generator 505, a first public key generator 506, a first symmetric key generator 507, and a first encryption processing unit 508.

The client terminal 600 includes a second pseudo random number generator 601, a second public key generator 602, a second symmetric key generator 603, and a second encryption processing unit 604.

First, an operation of performing encryption in the server 500 will be described as below.

The memory device 501 may include an array of flash memory chips as a main storage device of the server 500. In addition, the memory device 501 may include one or more SSDs.

If physical address information related to new data to be stored in the memory device 501 is input to the server 500, the address conversion unit 502 converts a logical address into a PPA and transmits the PPA to the initial key generating unit 503. Conversion into the PPA may be performed using software, such as an FTL described above.

Alternatively, when data is restored by changing a position of the memory device 501 in which data is stored, the PPA to be newly stored in the memory device 501 is transmitted to the initial key generating unit 503. The case that data is restored by changing a position of the memory device 501 in which data is stored is an example and may occur in a garbage collection process.

The initial key generating unit 503 generates an initial key value using a PPA. The initial key generating unit 503 may generate an initial key value in various manners with reference to the initial key generating unit 121 of FIG. 8 described above.

The hash function operational unit 504 generates a hash function value having a predetermined size regardless of the size of the initial key value using a hash function.

The first pseudo random number generating unit 505 outputs a pseudo random number value using the hash function value as a seed value. The pseudo random number value that is output from the first pseudo random number generator 505 is input to the first public key generator 506 and the first symmetric key generator 507.

The use of the first pseudo random number generator 505 in the server 500 corresponds to an option. If the first pseudo random number generator 505 is not used, a hash function operational value that is output from the hash function operational unit 504, is input directly to the first public key generator 506 and the first symmetric key generator 507.

The first public key generator 506 generates a public key to be shared with the client terminal 600 using a DH key exchange algorithm. The public key that is generated by the first public key generator 506 is transmitted to the client terminal 600.

The first symmetric key generator 507 generates a symmetric key according to the DH key exchange algorithm based on the public key transmitted from the client terminal 600 and the private key input from the hash function operational unit 504 or the first pseudo random number generator 505. The symmetric key corresponds to a final encryption key that is used in performing encryption.

According to the DH key exchange algorithm, the symmetric key that is generated in the server 500 and the symmetric key that is generated in the client terminal 600 are the same.

If data is restored by changing a position of the memory device 501 in which data is stored, the first encryption processing unit 508 performs encryption on data read from the memory device 501 using the private key value. For example, the encryption operation may be performed based on an encryption algorithm, such as an AES algorithm. Data that is encrypted by the first encryption processing unit 508 is stored in the changed PPA of the memory device 501.

Next, an operation of performing encryption in the client terminal 600 will be described as below.

The second pseudo random number generator 601 generates a pseudo random number value using a password or an IP address of the client terminal 600 as a seed value. The pseudo random number value that is generated by the second pseudo random number generator 601, is input to the second public key generator 602 and the second symmetric key generator 603.

The second public key generator 602 generates a public key to be shared with the server 500 using the DH key exchange algorithm. The public key that is generated by the second public key generator 602, is transmitted to the server 500.

The second symmetric key generator 603 generates a symmetric key according to the DH key exchange algorithm based on the public key that is transmitted from the server 500 and the private key that is input from the second pseudo random number generator 601.

The second encryption processing unit 604 performs encryption on data to be stored in the memory device 501 of the server 500 using the symmetric key value. For example, the encryption operation may be performed based on an encryption algorithm, such as an AES algorithm. Data that is encrypted by the second encryption processing unit 604, is transmitted to the server 500, and is stored in the memory device 501.

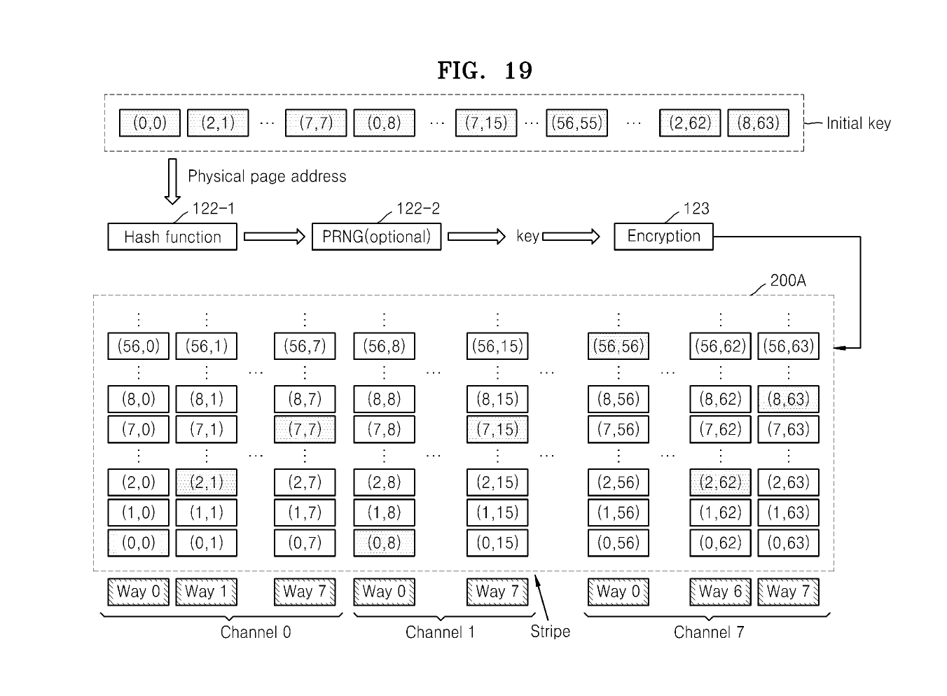

FIG. 19 is a conceptual diagram illustrating an encryption operation that may be used in the memory system 1000A or 1000B illustrated in FIG. 1 or 2 according to an embodiment of the inventive concept. The operation illustrated in FIG. 19 assumes a memory system using 8 channels and 8 ways.

Referring to FIG. 19, an initial key generating unit (see 121 of FIG. 8) may generate an initial key value by combining information related to PPAs to be stored in a physical storage area 200A of the memory system at a plurality of channels and a plurality of ways in the form of stripes. In FIG. 9, encryption may be performed according to the stripes. Since the number of initial keys that may constitute different physical offsets of pages that constitute one stripe is 64⁶⁴, the initial key value is not easily generated without page mapping information. Thus, in a server that uses a memory system having a plurality of channels and a plurality of ways, one stripe may be used as an encryption unit .

A private key may be generated from the initial key value using the hash function operational unit 122-1 and the pseudo random number generator 122-2 that are described with reference to FIG. 10. Here, the use of the pseudo random number generator 122-2 may be optional.

Then, the encryption processing unit 123 encrypts data to be stored in the physical storage area 200A of the memory system using the private key that is generated from the initial key value. Encrypted data is written into the physical storage region 200A of the memory system.

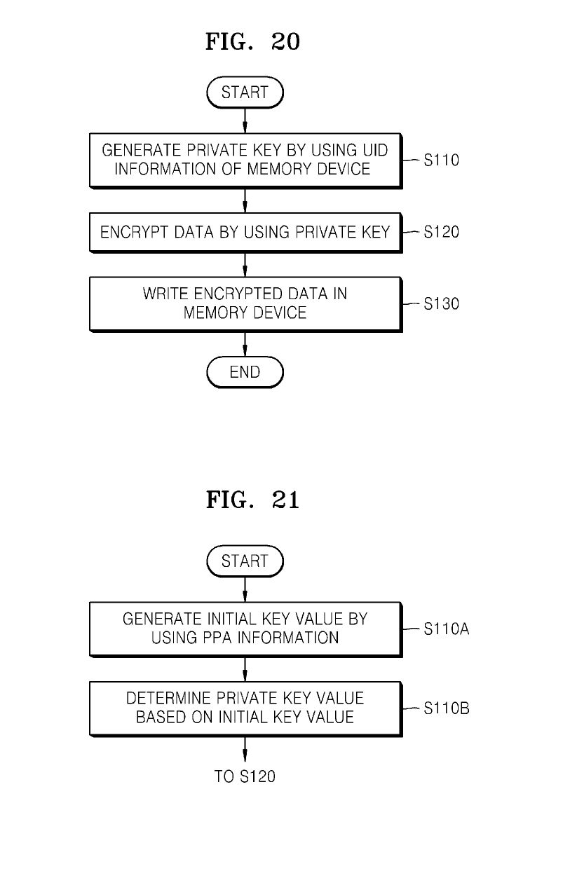

Next, an encryption method that may be used in a memory system according to an embodiment of the inventive concept will be described with reference to FIG. 20. The encryption method of FIG. 20 may be performed in the memory system 1000A or 1000B illustrated in FIG. 1 or 2, as well as various electronic devices, server systems, etc.

First, the memory controller 100 generates a private key using physical unique identification (PUID) information of a memory device 200 or 200′ in which data is to be stored (S110). For example, the PUID information may include information related to at least one PPA of the memory device 200 or 200′ in which data is to be stored. Alternatively, the PUID information may include unique identification (UID) information of the memory device 200 or 200′. Alternatively, the PUID information may include information that is obtained by combining information related to at least one PPA of the memory device 200 or 200′ in which data is to be stored, with the UID information of the memory device 200 or 200′.

Next, the memory controller 100 encrypts data to be stored in the memory device 200 or 200′ using the private key (S120). For example, an encryption algorithm, such as an AES algorithm, may be used in performing encryption.

Next, the memory controller 100 controls the memory system 1000A or 1000B to write encrypted data in a PPA of the memory device 200 or 200′ (S130). Here, the PPA where the write operation is performed corresponds to a PPA that is converted from a logical address where the write operation is required to be performed using an FTL.

FIG. 21 is a flowchart further illustrating the step of generating a private key in the encryption method of FIG. 20 according to an embodiment of the inventive concept.

First, the memory controller 100 generates an initial key value using PPA information to be stored in the memory device 200 or 200′ (S110A). For example, the initial key value may be generated according to any one of the approaches described with reference to FIGS. 12 through 15 and FIG. 19.

Next, the memory controller 100 determines a private key value based on the initial key value (S110B). For example, a private key value may be determined with a hash function value that is output by applying the initial key value to a hash function. In detail, using an MD5 hash function, a 128-bit output value may be obtained regardless of the size of the input initial key value. The 128-bit output value may be determined as a private key.

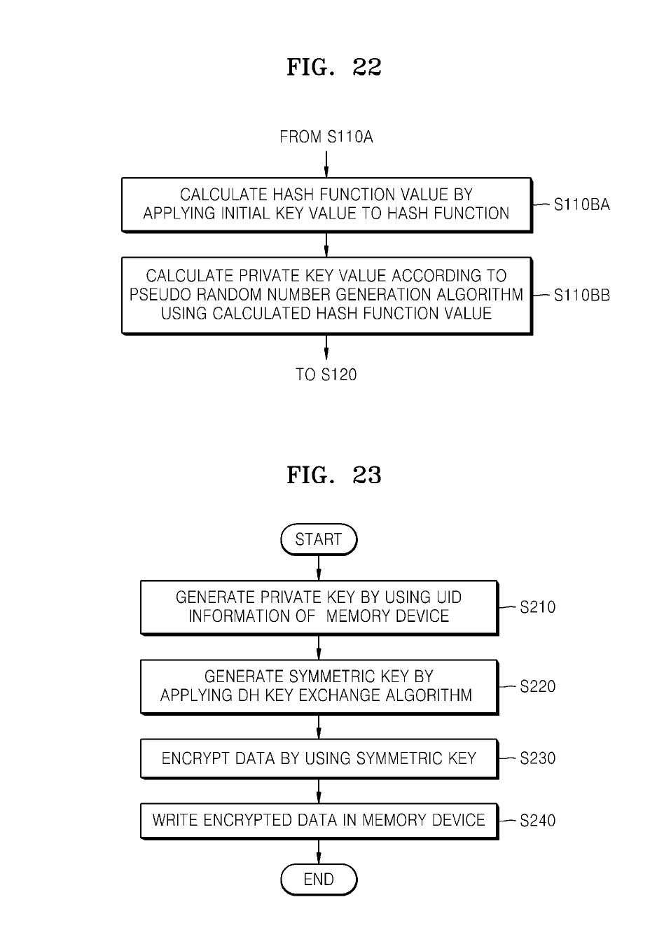

FIG. 22 is a flowchart further illustrating the sub-step of determining a private key value in the method of FIG. 21 according to an embodiment of the inventive concept.

First, the memory controller 100 calculates a hash function value by applying the initial key value to a hash function (S110BA). That is, the hash function value having a predetermined size may be calculated by applying the initial key value that is generated in operation S110A to a hash function regardless of the size of the initial key value.

Then, the memory controller 100 calculates a private key value with a pseudo random number value that is generated according to a pseudo random number generation algorithm in which the hash function value is used as a seed value (S110BB).

An encryption method for a memory system according to another embodiment of the inventive concept will be described with reference to FIG. 23. That is, FIG. 23 is a flowchart summarizing an encryption method using a DH key exchange algorithm. The encryption method of FIG. 23 may be performed in the memory system 1000A or 1000B illustrated in FIG. 1 or 2, a server system, and the like.

First, the memory controller 100 generates a private key using UID information of the memory device 200 or 200′ in which data is stored (S210). The operation of generating the private key has been described with reference to FIGS. 20 through 22 in detail, and thus, redundant descriptions thereof will be omitted.

Next, a symmetric key is generated in each of a memory system (or sever) and a host terminal (or client terminal) by applying the DH key exchange algorithm to the private key (S220). The operation of generating the symmetric key has been described with reference to FIG. 11 in detail, and thus, redundant descriptions thereof will be omitted.

Next, data to be stored in the memory device 200 or 200 is encrypted using the symmetric key (S230). For example, after data is encrypted using the symmetric key in the host terminal (client terminal), the encrypted data is transmitted to the memory system (server).

Next, the memory system (or server) receives the encrypted data and writes the received encrypted data in a PPA of the memory device 200 or 200′ (S240).

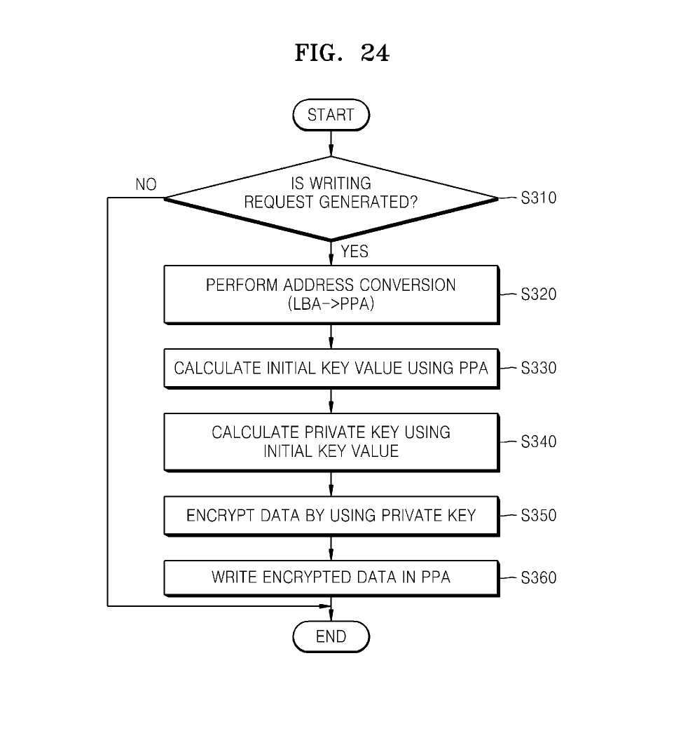

A write operation that may be performed in the memory system according to the current embodiment of the inventive concept will be described with reference to FIG. 24. That is, FIG. 24 is a flowchart summarizing a write operation that may be performed in the memory system illustrated in FIG. 1 and/or 2 according to an embodiment of the inventive concept, a server system, and the like.

First, the memory controller 100 determines whether a write request is generated in the memory system. For example, the write request may be generated by a write command that is received from a host (S310).

If the write request is generated (S310=YES), the memory controller 100 converts a logical address LBA where the write operation is required to be performed into a PPA using an FTL, as described above (S320).

Next, the memory controller 100 calculates the initial key value using the converted PPA information (S330). For example, the initial key value may be generated in the manners described with reference to FIGS. 12 through 15 or FIG. 19.

Next, the memory controller 100 calculates a private key using the initial key value (S340). For example, the private key value may be determined with a hash function value that is output by applying the initial key value to a hash function. Alternatively, the private key may be calculated with a pseudo random number value that is generated according to a pseudo random number generation algorithm in which the hash function value that is output by applying the initial key value to a hash function is as a seed value.

Next, the memory controller 100 encrypts data to be stored in the memory device 200 or 200′ using the private key (S350).

Next, the memory controller 100 writes the encrypted data in a PPA of the memory device 200 or 200′ (S360).

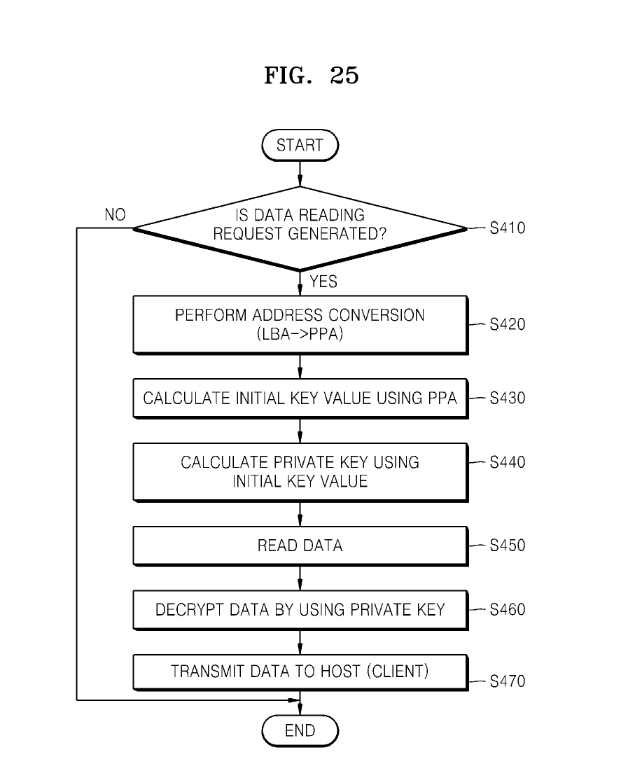

A read operation that may be performed in the memory system according to an embodiment of the inventive concept will be described with reference to FIG. 25. That is, FIG. 25 is a flowchart summarizing a read operation that may be performed in the memory system illustrated in FIG. 1 or 2 according to an embodiment of the inventive concept, a server system, and the like.

First, the memory controller 100 determines whether a read request is generated in the memory system 1000A or 1000B of FIG. 1 or 2 (S410). For example, a read request may be generated by a read command received from the host.

If the read operation is generated (S410=YES), the memory controller 100 converts a logical address LBA where the read operation is required to be performed into a PPA. As described above, the logical address LBA may be converted into the PPA using an FTL (S420).

The memory controller 100 calculates an initial key value using the converted PPA (S430). For example, the initial key value may be generated using any one of the approaches described above with reference to FIGS. 12 through 15 and FIG. 19.

Next, the memory controller 100 calculates a private key using the initial key value (S440). For example, a private key value may be determined with a hash function value that is output by applying the initial key value to a hash function. Alternatively, the private key may be calculated with a pseudo random number value that is generated according to a pseudo random number generation algorithm in which a hash function value that is output by applying the initial key value to a hash function is used as a seed value.

Then, the memory controller 100 reads data from the PPA of the memory device 200 or 200′ as converted (S450).

Next, the memory controller 100 decrypts the data that is read from the memory device 200 or 200′ using the private key (S460).

Next, the memory controller 100 transmits decrypted data to the host (or client) (S470).

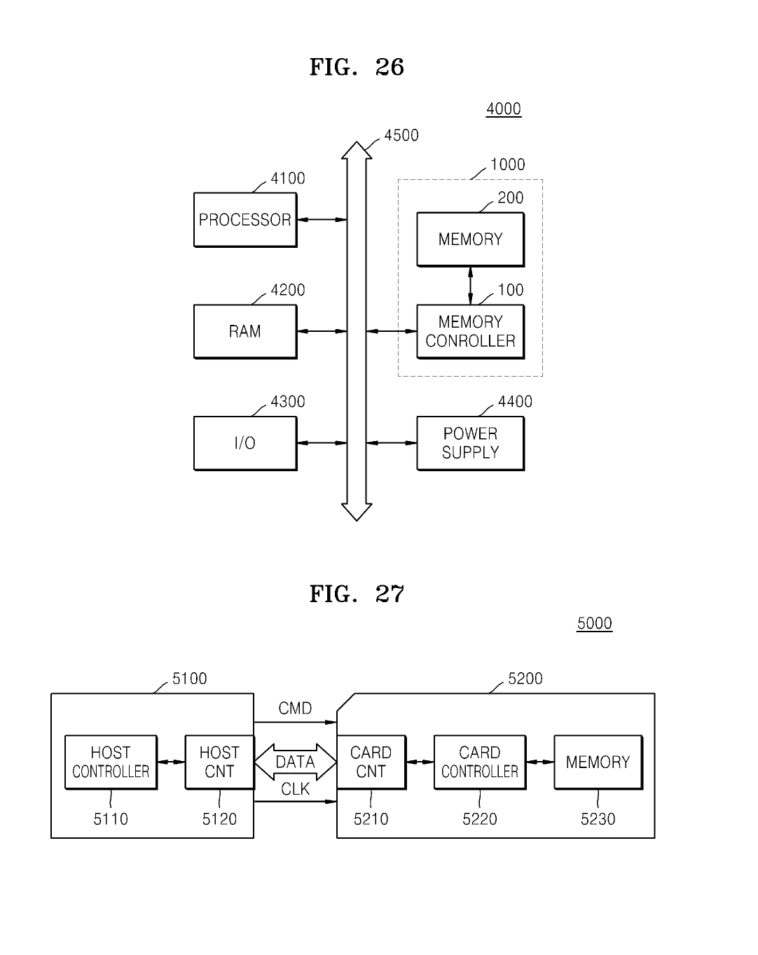

FIG. 26 is a block diagram of an electronic device 4000 including the memory system 1000A or 1000B illustrated in FIG. 1 or 2 according to an embodiment of the inventive concept.

Referring to FIG. 26, the electronic device 4000 may include a processor 4100, a random access memory (RAM) 4200, an input/output (I/O) unit 4300, a power supply unit 4400, and a memory system 1000. Although not shown, the electronic device 4000 may further include ports that may communicate with a video card, a sound card, a memory card, a universal serial bus (USB) device, or other electronic devices. The electronic device 4000 may be implemented with a personal computer (PC), or a portable electronic device, such as a laptop computer, a mobile phone, a personal digital assistant (PDA), or a camera.

The memory system 1000 illustrated in FIG. 26 may be the memory system 1000A or 1000B illustrated in FIG. 1 or 2. Thus, data to be stored in the memory device 200 may be encrypted using the encryption methods illustrated in FIGS. 20 and 23.

The processor 4100 may perform predetermined calculations or tasks. In some embodiment, the processor 4100 may be a micro-processor or a central processing unit (CPU). The processor 4100 may perform communication with the RAM 4200, the I/O unit 4300, and the memory system 1000 via a bus 4500, such as an address bus, a control bus, or a data bus. In one embodiment, the processor 4100 may be connected to an extended bus, such as a peripheral component interconnect (PCI) bus.

The RAM 4200 may store data required to perform an operation of the electronic device 4000. For example, the RAM 4200 may be a DRAM, a mobile DRAM, an SRAM, a PRAM, an FRAM, or an RRAM and/or MRAM.

The I/O unit 4300 may include an input unit, such as a keyboard, a keypad, or mouse, and an output unit, such as a printer or a display. The power supply unit 4400 may supply an operating voltage required to perform the operation of the electronic device 4000.

FIG. 27 is a block diagram of a memory card system 5000 including the memory system 1000A or 1000B illustrated in FIG. 1 or 2 according to an embodiment of the inventive concept.

Referring to FIG. 27, the memory card system 5000 may include a host 5100 and a memory card 5200. The host 5100 may include a host controller 5110 and a host connector 5120. The memory card 5200 may include a card connector 5210, a card controller 5220, and a memory device 5230.

The card controller 5220 and the memory device 5230 illustrated in FIG. 27 may be the memory controller 100 and the memory device 200 or 200′ illustrated in FIG. 1 or 2.

Data may be written into the memory card 5200, or data may be read from the memory card 5200 via the host 5100. The host controller 5110 may transmit a command CMD, a clock signal CLK that is generated by a clock generator (not shown) in the host 5100, and data (DATA) to the memory card 5200 via the host connector 5120.

The card controller 5220 may encrypt data using the encryption method illustrated in FIGS. 20 and 23 and may store the encrypted data in the memory device 5230 in response to the command CMD received from the card connector 5210.

The memory card 5200 may a compact flash card (CFC), a micro-drive, a smart media card (SMC), a multimedia card (MMC), a security digital card (SDC), a memory stick, a USB flash memory driver, or the like.

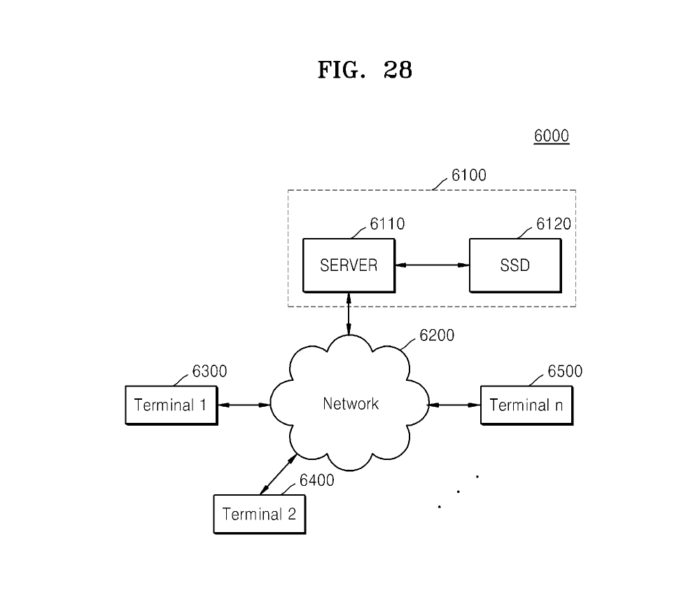

FIG. 28 is a block diagram of a networked (6200) server system 6100 including an SSD 6120 according to an embodiment of the inventive concept.

Referring to FIG. 28, a network system 6000 according to the present embodiment of the inventive concept may include the server system 6100 and a plurality of terminals 6300, 6400, and 6500 that are connected to one another via the network 6200. The server system 6100 may include a server 6110 that processes requests received from the plurality of terminals 6300, 6400, and 6500 connected to the network 6200, and the SSD 6120 that stores data corresponding to the requests received from the terminals 6300, 6400, and 6500. In this case, the SSD 6120 may be the memory system 1000A or 1000B illustrated in FIG. 1 or 2. In addition, the server 6110 may be the server 400 or 500 illustrated in FIG. 17 or 18.

A memory system according to the inventive concept may be embedded using various types of packages. For example, the memory system according to the inventive concept may be embedded using packages, such as a package on package (POP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metricquad flat pack (MQFP), thin quad flatpack (TQFP), small outline (SOIC), shrink small outline package (SSOP), thin small outline (TSOP), thin quad flatpack (TQFP), system in package (SIP), multi chip package (MCP), wafer-level fabricated package (WFP), and wafer-level processed stack package (WSP).

While the inventive concept has been particularly shown and described with reference to exemplary embodiments thereof, it will be understood that various changes in form and details may be made therein without departing from the scope of the following claims.

What is claimed is:

1. An encryption method for use in a memory system including a nonvolatile memory device, the method comprising:
receiving data to be stored in the nonvolatile memory device;
generating a private key using physical unique identification (PUID) information related to the nonvolatile memory device;
encrypting the data using the private key; and
programming the encrypted data in the nonvolatile memory device.

2. The encryption method of claim 1, wherein the physical unique identification (PUID) information comprises information related to at least one physical page address (PPA) of the nonvolatile memory device.

3. The encryption method of claim 1, wherein the physical unique identification (PUID) information comprises information obtained by combining information related to at least one physical page address (PPA) of the nonvolatile memory device with unique identification (UID) information related to the nonvolatile memory device.

4. The encryption method of claim 1, wherein the generating of the private key comprises:
generating an initial key value using the information related to at least one physical page address (PPA) of the nonvolatile memory device; and
determining a private key value having an initially-set size based on the initial key value.

5. The encryption method of claim 4, wherein the generating of the initial key value comprises:
generating the initial key value by combining the information related to at least one physical page address (PPA) of the nonvolatile memory device with UID information of the nonvolatile memory device.

6. The encryption method of claim 4, wherein the generating of the initial key value comprises:
generating the initial key value based on bitmap information used to differentiate physical page addresses (PPAs) in which the data is to be stored, and physical page addresses (PPAs) at which the data will not be stored.

7. The encryption method of claim 4, wherein the nonvolatile memory device comprises a plurality of memory chips, and the generating of the initial key value comprises:
generating the initial key value by combining unique identification (UID) information related to the plurality of memory chips with information related to physical page addresses at which data is to be stored in the plurality of memory chips.

8. The encryption method of claim 4, wherein the nonvolatile memory device comprises a plurality of memory chips arranged in a plurality of channels and a plurality of ways, and the generating of the initial key value comprises:
generating the initial key value by combining information related to physical page addresses (PPAs) to be stored in the plurality of channels and the plurality of ways in a form of stripes.

9. The encryption method of claim 4, wherein the determining of the private key value comprises:
determining the private key value using a hash function value generated by applying the initial key value to a hash function.

10. The encryption method of claim 4, wherein the determining of the private key value comprises:
generating a hash function value by applying the initial key value to a hash function; and
determining the private key value as a value generated according to a pseudo random number generation algorithm in which the hash function value is used as a seed value.

11. The encryption method of claim 1, wherein the memory system is configured to exchange data with a terminal, and the method further comprises:
generating a symmetric key in the memory system and the terminal according to a key exchange algorithm using the private key, wherein the data to be stored in the nonvolatile memory device is encrypted using the symmetric key.

12. A memory system comprising:
a nonvolatile memory device comprising at least one memory chip; and
a memory controller that controls operation of the nonvolatile memory device to encrypt data using information related to physical page addresses (PPAs) of the nonvolatile memory device, and to write the encrypted data to the nonvolatile memory device according to a physical page address (PPA) corresponding to a logical address for the data.

13. The memory system of claim 12, wherein the memory controller comprises:
a processor that converts logical address information controlling a write operation into PPA information related to at least one PPA of the nonvolatile memory device; and
an encryption module that encrypts the data using the PPA information.

14. The memory system of claim 13, wherein the encryption module comprises:
an initial key generating unit that generates an initial key value using the information related to at least one PPA;
a private key generating unit that generates a private key value having an initially-set size based on the initial key value; and
an encryption processing unit that encrypts the data using the private key.

15. The memory system of claim 13, wherein the encryption module comprises:
an initial key generating unit that generates an initial key value using the PPA information;
a private key generating unit that generates a private key value having an initially-set size based on the initial key value;
a symmetric key generating unit that generates a symmetric key in each one the memory system and a terminal exchanging data with the memory system according to a key exchange algorithm using the private key; and
an encryption processing unit that encrypts the data using the symmetric key.

16. An encryption method for use in a memory system including a flash memory device having associated physical unique identification (PUID) information, the memory system being connected to a host, and the method comprising:
receiving a write command, write data and a logical address for the write data in the memory system as communicated by the host;
generating a private key using the PUID information;
encrypting the write data using the private key to generate encrypted data; and
programming the encrypted data in the flash memory device.

17. The encryption method of claim 16, wherein the PUID information comprises information related to at least one physical page address (PPA) of the flash memory device.

18. The encryption method of claim 16, further comprising:
deriving the PUID information by combining information related to at least one PPA with unique identification (UID) information related to the flash memory device.

19. The encryption method of claim 18, wherein the generating of the private key comprises:
generating an initial key value using the information related to at least one PPA; and
determining a private key value having an initially-set size based on the initial key value.

20. The encryption method of claim 19, wherein the generating of the initial key value comprises:
generating the initial key value by combining the information related to at least one PPA with the UID information.
